(19) United States
(12) Patent Application Publication
(10) Pub. No.: US 2017/0007866 A1
(43) Pub. Date: Jan. 12, 2017

(54) Flame Arrester

(71) Applicant: KULR TECHNOLOGY CORPORATION, Santa Clara, CA (US)

(72) Inventors: Timothy Ray Knowles, San Diego, CA (US); Michael Gerald Carpenter, San Diego, CA (US); Yoshio Robert Yamaki, San Diego, CA (US); Michael Mo, Saratoga, CA (US)

(21) Appl. No.: 15/203,757

(22) Filed: Jul. 6, 2016

Related U.S. Application Data
(60) Provisional application No. 62/189,018, filed on Jul. 6, 2015.

(51) Int. Cl. A62C 4/00; A62C 3/06; H01M 2/16

(52) U.S. Cl. CPC A62C 4/00; H01M 2/1613; H01M 2/1686; A62C 3/06; H01M 2200/10

(57) ABSTRACT

A flame arrester comprises: carbon fiber layers; and one or more connecting layers. The carbon fiber layers are separated from each other by the one or more connecting layers. Carbon fibers of the carbon fiber layers are substantially perpendicular to the plane of the one or more connecting layers.

### CROSS REFERENCE

This application claims priority from a provisional patent application entitled “Flame Arrester” filed on Jul. 6, 2015 and having application No. 62/189,018. Said application is incorporated herein by reference.

### FIELD OF INVENTION

The present disclosure relates to a flame arrester and, in particular, to a flame arrester having layers of carbon fibers.

### BACKGROUND

Flame arresters are safety devices that absorb heat from a flame to reduce or eliminate such flame from propagating. Flame arresters are commonly used in fuel storage tanks, fuel gas pipelines, safety storage cabinets for flammable materials, and other fields. More recently, flame arresters have been used in vents for a lead-acid battery to prevent sparks and/or flames from reaching inside a battery. See US published patent application 2013/0302656 for more details regarding such flame arrester for a lead-acid battery. However, flame arresters have not addressed other battery issues.

For instance, lithium-ion batteries are prone to shorting and possibly flaring due to that internal short. When a lithium-ion battery flare, sparks and flames from that battery can migrate to adjacent areas which can injure a user or cause further damage to the respective device that the battery was used to power. Typically, bulky metal cases are used to house the individual battery cells such that the bulky case can isolate the sparks and flames caused by a flaring battery cell. Unfortunately, such cases are expensive and are much too heavy for many applications.

Therefore, there exists a need for a new flame arrester that can prevent or reduce flames from propagating. There also exists a need for a flame arrester that is suited for applications that require a lighter solution.

### SUMMARY OF INVENTION

Briefly, the present disclosure discloses a flame arrester, comprising: carbon fiber layers; and one or more connecting layers, wherein the carbon fiber layers are separated from each other by the one or more connecting layers.

### DESCRIPTION OF THE DRAWINGS

The foregoing and other objects, aspects, and advantages of the present disclosure can be better understood from the following detailed description of the preferred embodiment of the disclosure when taken in conjunction with the accompanying drawings.

FIG. 1 illustrates a flame arrester of the present disclosure having layers of carbon fibers interconnected with layers of one or more materials.

FIG. 2 illustrates a side view of a flame arrester of the present disclosure.

FIG. 3 illustrates a block of flame arresters of the present disclosure.

### DETAILED DESCRIPTION OF THE PREFERRED EMBODIMENTS

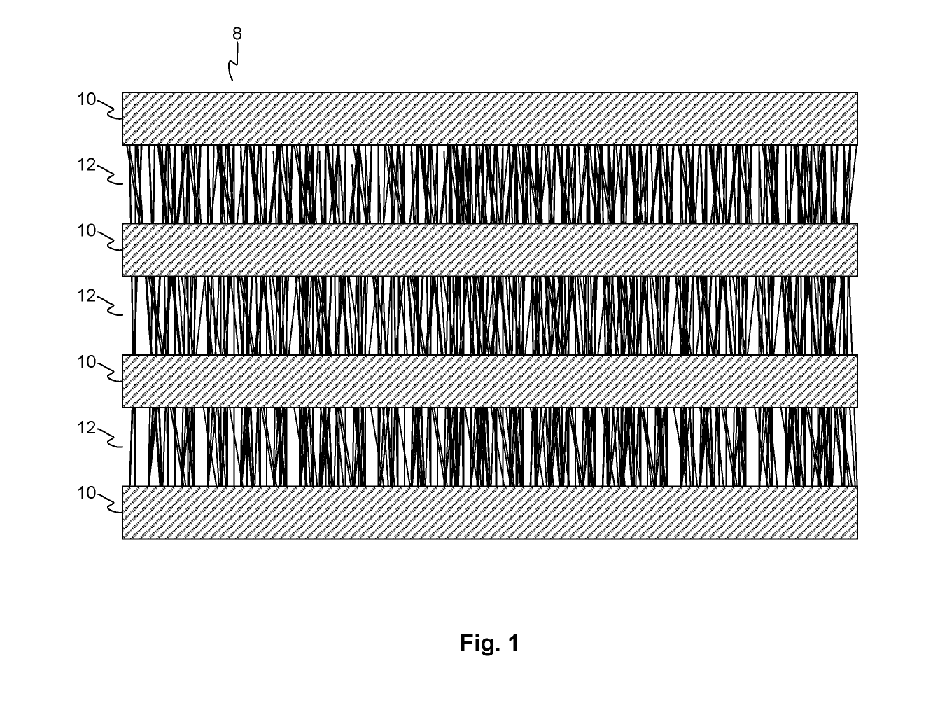

FIG. 1 illustrates a flame arrester of the present disclosure having layers of carbon fibers interconnected with layers of one or more materials. A flame arrester 8 can be in a panel form factor (as illustrated in FIG. 1) or other form factor, depending on the particular application of use. To aid in the understanding of the present disclosure, a panel form factor will be used in the description of the present disclosure. However, it is understood that a person having ordinary skill in the art can provide for other form factors based on the present disclosure. Those other form factors are intended to be included in the present disclosure as well.

The flame arrester 8 comprises carbon fiber layers 12 and connecting layers 10. Each of the carbon fiber layers 12 are sandwiched between at least two connecting layers. The connecting layers 10 can comprise one or more various materials, including aluminum, polymer, steel, and/or other materials. The carbon fiber layers 12 and the connecting layers 10 are oriented parallel to each other.

Generally, a glue-like substance (e.g., a resin) is disposed on a side of a connecting layer 10. Next, the carbon fibers of the carbon fiber layers 12 are disposed onto that side of the connecting layer 10. The glue-like substance aids in securing a first end of the carbon fibers to one of the connecting layers 10 and a second end of the carbon fibers to another one of the connecting layers 10. The carbon fibers are positioned substantially perpendicular to the connecting layers 10. In particular, the carbon fibers are substantially perpendicular to the parallel planes of the connecting layers 10. The density of the carbon fibers can be adjusted based on the required gas permeability of the carbon fiber layers and the amount of heat absorption desired.

The second end of the carbon fibers is disposed into a glue-like substance to another side of a different connecting layer 10. Thus, the basic structure of a flame arrester panel can be at least one carbon fiber layer and two interconnecting layers. Additionally, layers of carbon fibers and interconnecting layers can be added to this sandwich structure as desired. The sandwich structure of the flame arrester 8 provides for a very strong barrier to absorb heat and kinetic energy. Additionally, other manufacturing methods can be employed to dispose of and connect the carbon fiber layers to the connecting layers.

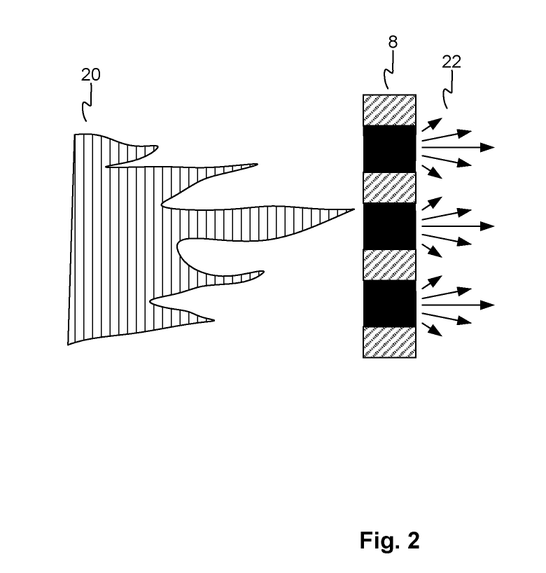

FIG. 2 illustrates a side view of a flame arrester of the present disclosure. The operation of the flame arrester can be illustrated from the side view of the flame arrester 8. A flame 20 can be applied to a first side of the flame arrester 8. The flame arrester 8 can absorb the heat energy from the flame 20 such that the flame 20 does not burn through the flame arrester 8 to the other side of the flame arrester 8. However, since the carbon fibers 12 are gas permeable, any gases entering from the flame 20 side can exit through the other side 22 of the flame arrester 8.

For battery applications, the flame arrester 8 can be used to secure one or more battery cells, such that when one of the battery cells flares, the flame arrester can limit the flares by absorbing the heat energy from the flaring. The width of the flame arrester 8, the density of the carbon fibers, and the height of the connecting layers can be dependent on the amount of heat and pressure needed to be safeguarded by the flame arrester 8.

With respect to manufacturing a flame arrester, the flame arrester can be produced using various methods by disposing carbon fibers onto a substrate. In this case, the substrate can be the connecting layers. The disposition of carbon fibers and connecting layers can be alternated to form the flame arrester, where the carbon fibers are disposed substantially perpendicular and/or substantially canted to provide structural give. Furthermore, the carbon fibers can be disposed onto panels of the connecting layers with a predefined density of fibers on the panels to form a block. The formed block can then be cut such that multiple flame arresters with one or more preset widths can be produced from the block of interconnecting layers and carbon fibers. In such manner, each flame arrester can have its own predefined width to fit a particular application.

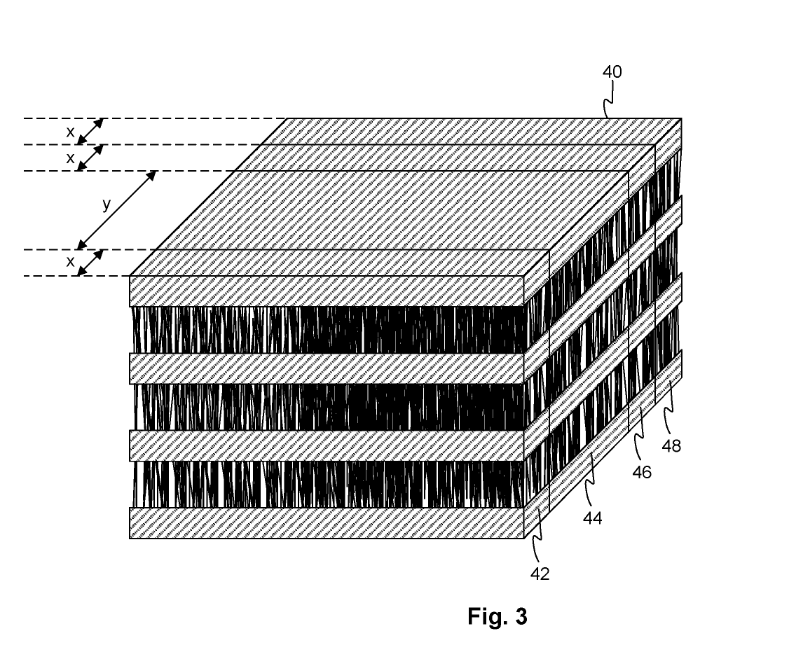

FIG. 3 illustrates a block of flame arresters of the present disclosure. In an example of a formed block 40 of carbon fibers and interconnecting layers, the formed block can be machined cut along a plane of the formed block 40 to form distinct flame arresters 42, 44, 46, and 48. The flamer arresters 42-28 can have one or more predefined widths. For instance, flame arresters 42, 46, and 48 can have a width of x and the flame arrester 44 can have a width of y. The actual lengths of x and y can be determined based on the application for the respective flame arrester. Once cut, the flame arresters 42-48 can be distributed as individual flame arrester panels. To aid in the understanding of the present disclosure, the formed block 40 has not been separated to illustrate where the block 40 can be cut to obtain the flame arrester panels 42-28.

While the present disclosure has been described with reference to certain preferred embodiments or methods, it is to be understood that the present disclosure is not limited to such specific embodiments or methods. Rather, it is the inventor's contention that the disclosure be understood and construed in its broadest meaning as reflected by the following claims. Thus, these claims are to be understood as incorporating not only the preferred methods described herein but all those other and further alterations and modifications as would be apparent to those of ordinary skilled in the art.

We Claim:

1. A flame arrester, comprising:
carbon fiber layers; and
one or more connecting layers,
wherein the carbon fiber layers are separated from each other by the one or more connecting layers.

2. The flame arrester of claim 1 wherein the connecting layers comprise one or more of the following: including aluminum, polymer, and steel.

3. The flame arrester of claim 1 wherein carbon fibers of the carbon fiber layers are substantially perpendicular to the one or more connecting layers.

4. The flame arrester of claim 1 wherein the flame arrester is a panel and wherein the carbon fiber layers and the connecting layers are oriented in parallel planes.

5. The flame arrester of claim 1 wherein the connecting layers have a resin to hold a first end and a second end of the carbon fibers in place.

6. The flame arrester of claim 1 wherein density of the carbon fibers of the carbon fiber layers is a function of gas permeability and heat absorption.

7. A flame arrester, comprising:
carbon fiber layers; and
one or more connecting layers,
wherein the carbon fiber layers are separated from each other by the one or more connecting layers, and
wherein carbon fibers of the carbon fiber layers are substantially perpendicular to the one or more connecting layers.

8. The flame arrester of claim 7 wherein the connecting layers comprise one or more of the following: including aluminum, polymer, and steel.

9. The flame arrester of claim 7 wherein the flame arrester is a panel and wherein the carbon fiber layers and the connecting layers are oriented in parallel planes.

10. The flame arrester of claim 7 wherein the connecting layers have a resin to hold a first end and a second end of the carbon fibers in place.

11. The flame arrester of claim 7 wherein density of the carbon fibers of the carbon fiber layers is a function of gas permeability and heat absorption.

12. A flame arrester panel, comprising:
carbon fiber layers; and
one or more connecting layers,
wherein the carbon fiber layers and the connecting layers are disposed in parallel planes,
wherein the connecting layers comprise one or more of the following: including aluminum, polymer, and steel,
wherein the carbon fiber layers are separated from each other by the one or more connecting layers,
wherein carbon fibers of the carbon fiber layers are substantially perpendicular to the one or more connecting layers,
wherein the connecting layers have a resin to hold a first end and a second end of the carbon fibers in place, and
wherein density of the carbon fibers of the carbon fiber layers is a function of gas permeability and heat absorption.
